(19) United States
(12) Patent Application Publication
(10) Pub. No.: US 2008/0208669 A1
(43) Pub. Date: Aug. 28, 2008

(54) HOTEL SYSTEM AND METHOD

(76) Inventor: Theodore TENG, Plano, TX (US)

Correspondence Address: HAYNES AND BOONE, LLP, 901 Main Street, Suite 3100, Dallas, TX, 75202, US

(21) Appl. No.: 12/039,249

(22) Filed: Feb. 28, 2008

Related U.S. Application Data
(60) Provisional application No. 60/892,011, filed on Feb. 28, 2007.

(51) Int. Cl. G06Q 10/00; G06Q 30/00

(52) U.S. Cl. 705/8; 705/10

(57) ABSTRACT

A hotel system and method is described. In an exemplary embodiment, a hotel is located on one or more floors of a building that is primarily used for purposes other than lodging services, and the size of the hotel and/or its facilities and/or services are scaled to primarily meet the needs and demands of the tenants and visitors of the building.

### CROSS REFERENCE TO RELATED APPLICATION

This application claims the benefit of the filing date of U.S. application No. 60/892,011, filed on Feb. 28, 2007, the disclosure of which is incorporated herein by reference.

### BACKGROUND

The present disclosure relates in general to a hotel system and method, and in particular to a hotel system and method according to which a hotel is located in a building that is primarily used for purposes other than hotel or lodging services such as, for example, a major office building.

### BRIEF DESCRIPTION OF THE DRAWINGS

FIG. 1 is a diagrammatic view of a hotel system according to an exemplary embodiment, the hotel system including a hotel located in a downtown office building.

FIG. 2 is a flow chart illustration of a method of providing lodging services using the hotel system of FIG. 1 according to an exemplary embodiment.

FIG. 3 is a flow chart illustration of a method of marketing lodging and other services provided by the hotel of FIG. 1 according to an exemplary embodiment.

FIG. 4 is a diagrammatic view of a hotel system according to an exemplary embodiment, the hotel system including the hotel of FIG. 1 and an office suite located in the downtown office building of FIG. 1.

FIG. 5 is a flow chart illustration of a method using the hotel system of FIG. 6 according to an exemplary embodiment.

FIG. 6 is a plan view of the hotel of FIG. 1 according to an exemplary embodiment.

FIG. 7 is a plan view of the hotel of FIG. 1 according to an exemplary embodiment.

### DETAILED DESCRIPTION

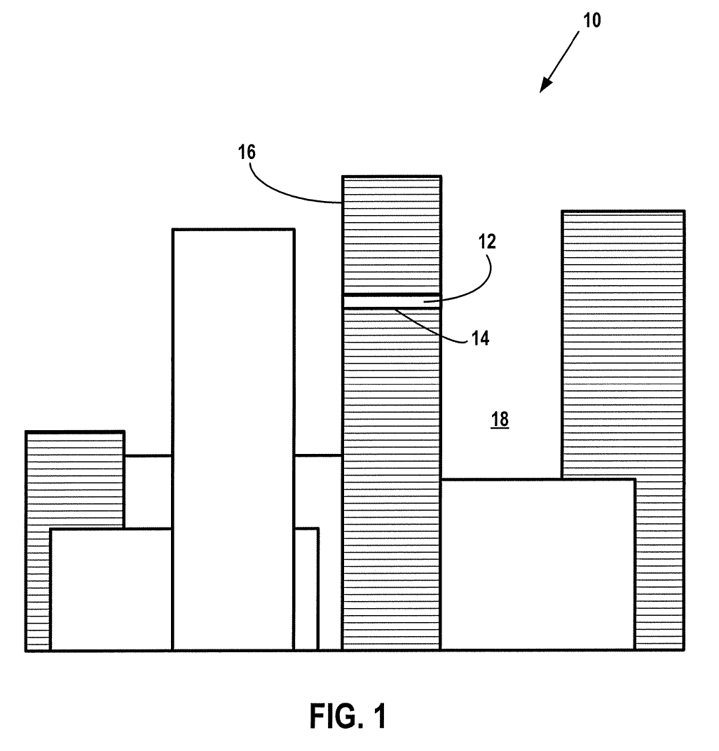

In an exemplary embodiment, as illustrated in FIG. 1, a hotel system is generally referred to by the reference numeral 10 and includes a hotel 12 located on a floor 14 of a major office building 16 in a downtown area 18. In an exemplary embodiment, the office building 16 is primarily used for purposes other than hotel or lodging services. In an exemplary embodiment, the office building 16 is primarily used as an office building. In several exemplary embodiments, instead of, or in addition to the floor 14, the hotel 12 is located on one or more other floors of the office building 16.

In an exemplary embodiment, the hotel 12 occupies the floor 14 of the office building 16 and includes guest rooms. In an exemplary embodiment, in addition to guest rooms, the hotel 12 further includes a reception lounge, one or more small meeting facilities, one or more office facilities, and/or any combination thereof. In an exemplary embodiment, the hotel 12 includes a reception lounge serving, for example, continental breakfast and/or evening snacks.

In an exemplary embodiment, the hotel 12 does not include ballrooms, restaurants, bars, swimming pools and other public facilities. In an exemplary embodiment, the hotel 12 does not have conventions, relatively large meetings, weddings, social events, church groups, Sunday brunches, happy hours, lady's nights, or reunions.

In an exemplary embodiment, the space of the building 16 is 1 million square feet, the space of the hotel 12 is 25,000 square feet, and the hotel 12 occupies only the floor 14. In an exemplary embodiment, the space of the building 16 is 1 to 1.5 million square feet and the hotel 12 includes about 40 guest rooms.

In an exemplary embodiment, the space of the building 16 is 1.7 million square feet, the space of the hotel 12 is 46,000 square feet, and the hotel 12 occupies at least one other floor in addition to the floor 14. In an exemplary embodiment, the space of the building is 1.7 million square feet and the hotel 12 includes about 55 to about 60 guest rooms.

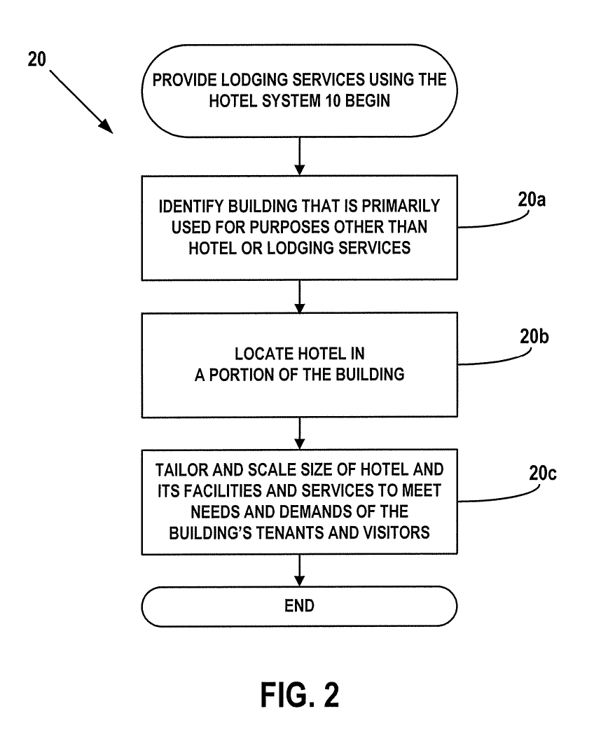

In an exemplary embodiment, as illustrated in FIG. 2 with continuing reference to FIG. 1, a method of providing lodging services using the hotel system 10 is generally referred to by the reference numeral 20 and includes identifying the building 16 in step 20a; locating the hotel 12 in a portion of the building 16 such as, for example, the floor 14, in step 20b; and, in step 20c, tailoring and scaling the size of the hotel and its facilities and services to primarily meet the lodging needs and demands of the tenants of, and visitors to, the building 16.

In an exemplary embodiment, to scale the size of the hotel 12 and its facilities and services to meet the needs and demands of the tenants of, and the visitors to, the building 16 in the step 20c of the method 20, the space of the building 16 in, for example, square feet, is determined. In an exemplary embodiment, after determining the space of the building 16, the space of the hotel 12 in, for example, square feet, is sized to range from about 1% to about 10% of the space of the building 16. In an exemplary embodiment, the space of the hotel 12 is sized to range from about 2% to about 5% of the space of the building 16. In an exemplary embodiment, the space of the hotel 12 is sized to range from about 3% to about 5% of the space of the building 16. In an exemplary embodiment, the space of the hotel 12 is sized to be about 2% of the space of the building 16. In an exemplary embodiment, the space of the hotel 12 is sized to be about 3% of the space of the building 16. In an exemplary embodiment, the space of the hotel 12 is sized to be about 4% of the space of the building 16. In an exemplary embodiment, the space of the hotel 12 is sized to be about 5% of the space of the building 16.

In an exemplary embodiment, in addition to, or instead of the foregoing, to scale the size of the hotel 12 and its facilities and services to meet the needs and demands of the tenants of, and the visitors to, the building 16 in the step 20c of the method 20, the occupancy of the building 16 is taken into account and the size of the hotel 12 is adjusted accordingly. In an exemplary embodiment, if the occupancy of the building 16 is high, the size of the hotel 12 is increased. In an exemplary embodiment, if the occupancy of the building 16 is low, the size of the hotel 12 is decreased.

In an exemplary embodiment, in addition to, or instead of the foregoing, to scale the size of the hotel 12 and its facilities and services to meet the needs and demands of the tenants of, and the visitors to, the building 16 in the step 20c of the method 20, one or more other factors are taken into account such as, for example, the nature of the businesses practiced and/or carried out by the tenants of the building 16.

In several exemplary embodiments, in addition to, or instead of the foregoing, in the step 20c of the method 20, the size of the hotel 12 and its facilities and services may be tailored and scaled to meet the needs and demands of the tenants of, and the visitors to, the building 16 in a wide variety of ways, processes and/or methods such as, for example, by conducting formal and/or informal surveys of the tenants of the building 16 to determine their needs, and then tailoring and/or scaling the services of the hotel 12 in response to the results of the surveys.

During operation, in an exemplary embodiment, as a result of the method 20, the hotel 12 meets the lodging needs and demands of the tenants of, and visitors to, the building 16. As a result, the hotel 12 operates as a dedicated service hotel located onsite, that is, in the building 16. In an exemplary embodiment, for a guest of the hotel 12, there is only an elevator commute from the hotel 12 to the tenant of the building 16 that the guest is visiting. In several exemplary embodiments, in addition to primarily meeting the lodging needs and demands of the tenants of, and the visitors to, the building 16, the hotel 12 meets the lodging needs of other visitors to the downtown area 18.

During operation, in several exemplary embodiments, the location of the hotel 12 in the building 16 promotes communication between the tenants of the building 16 and the hotel 12. In several exemplary embodiments, the location of the hotel 12 in the building 16 promotes the working relationship between the tenants of the building 16 and the hotel 12. As a result of the promotion of communication and the working relationship between the hotel 12 and its primary customers, the tenants of the building 16, the employees of the hotel 12 feel valued and experience a relatively steady flow of hotel business and/or full-time work. As a result, employee retention at the hotel 12 is improved.

During operation, in several exemplary embodiments, the location of the hotel 12 in the building 16 enables the hotel 12 to provide highly personalized service, on behalf of the tenant of the building 16, to the visitor of the building 16 that is associated with the tenant and a guest of the hotel 12. In an exemplary embodiment, the hotel 12 may be considered to be a corporate bed and breakfast. In several exemplary embodiments, each guest of the hotel 12 is treated like a Very Important Person (“VIP”). In an exemplary embodiment, due at least in part to the relatively small number of rooms in the hotel 12 and/or the association of the guest with the friends of the hotel 12, that is, with the tenants of the building 16, each guest of the hotel 12 is treated so that the guest feels like a VIP.

During operation, in several exemplary embodiments, since the hotel 12 is scaled to meet the needs of the tenants and visitors of the building 16, the hotel 12 usually does not experience disruptions associated with major events in the downtown area 18 or the surrounding area such as, for example, conventions, relatively-large meetings, sports events, concert events, etc.

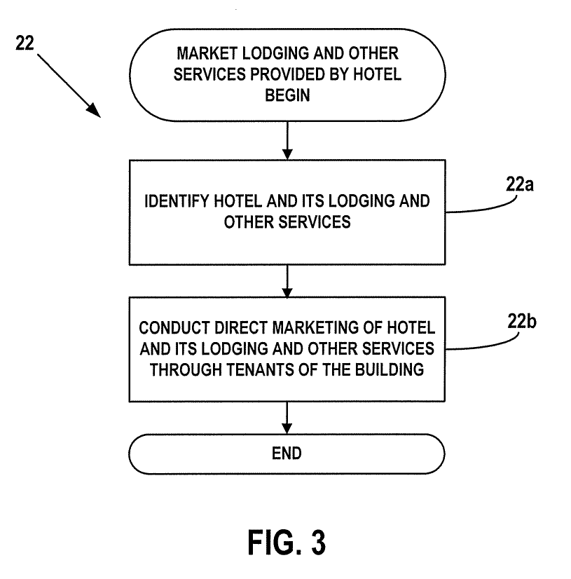

In an exemplary embodiment, as illustrated in FIG. 3 with continuing reference to FIGS. 1 and 2, a method of marketing the lodging and other services provided by the hotel 12 is generally referred to by the reference numeral 22 and includes identifying the hotel and its lodging and other services in step 22a, and conducting direct marketing of the hotel 12 and its lodging and other services through the tenants of the building 16 in step 22b.

In an exemplary embodiment, to identify the hotel 12 and its lodging and other services in the step 22a of the method 22, the hotel 12 and/or its lodging and other services are identified by the term “HOTEL ON” followed by floor number of the floor 14 of the building 16. In an exemplary embodiment, if the floor number of the floor 14 of the building 16 is 27, then the hotel 12 and/or its lodging and other services is identified by the term “HOTEL ON 27”. In an exemplary embodiment, in a marketing and/or branding context, the hotel 12 and/or its lodging and other services is identified by the term “HOTEL ON” followed by the circled floor number of the floor 14 of the building 16, with the circle around the floor number suggesting an elevator button. In an exemplary embodiment, if the floor number of the floor 14 of the building 16 is 27, then the hotel 12 and/or its lodging and other services is identified by the following term:

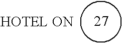

In an exemplary embodiment, to conducting direct marketing of the hotel 12 and its lodging and other services through the tenants of the building 16 in the step 22b of the method 22, the tenants of the building 16 in which the hotel 12 is located directly market the hotel 12 and its lodging and other services to, for example, employees and/or persons who constitute the tenants, employees of the tenants who may be visiting from other geographic areas, persons who visit the tenants, any combination thereof, and/or other persons. In an exemplary embodiment, instead of attempting to reach broad and too-far-away places through advertising, branding, travel agencies and/or reservation distributions, the marketing of the hotel 12 is conducted directly through the tenants of the building 16, thereby reducing costs such as intermediary costs. In several exemplary embodiments, employees of the tenants of the building 16 contact the hotel 12 directly to make reservations for visitors to the building 16 that are associated with the tenants. As a result, the cost of distribution is greatly reduced. As another result, the relationships between the tenants of the building 16 and the hotel 12 is strengthened and improved.

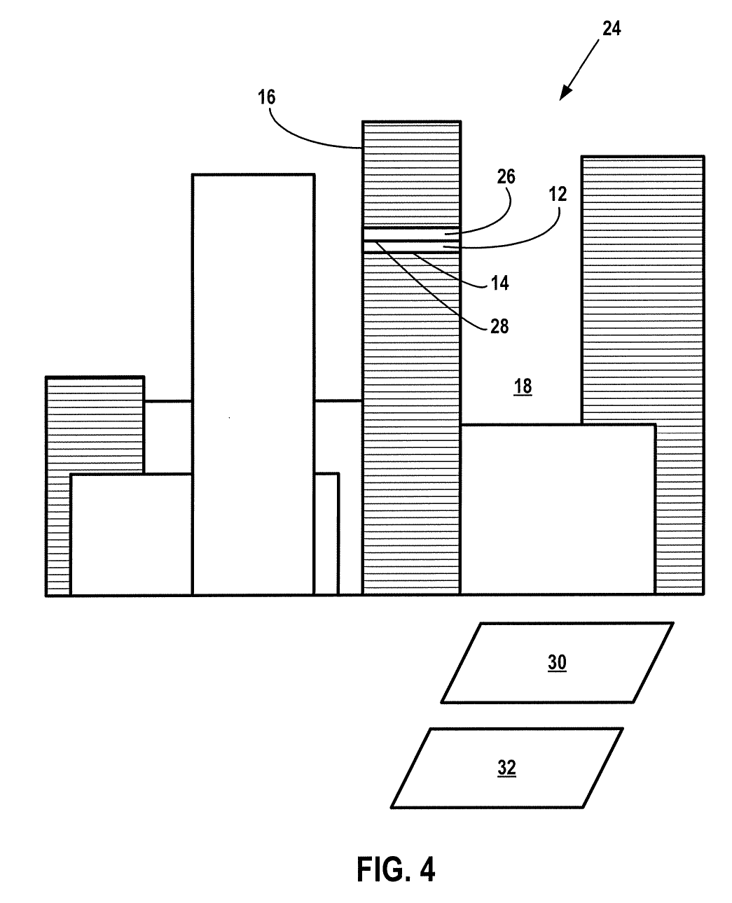

In an exemplary embodiment, as illustrated in FIG. 4 with continuing reference to FIGS. 1, 2 and 3, a hotel system is generally referred to by the reference numeral 24 and includes the hotel 12 located on the floor 14 of the office building 16 in the downtown area 18. The system 24 further includes an office suite 26 located on a floor 28 of the office building 16. A plurality of parking spaces 30 are reserved for, or allocated to, the hotel 12, and a plurality of parking spaces 32 are reserved for, or allocated to, the office suite 26.

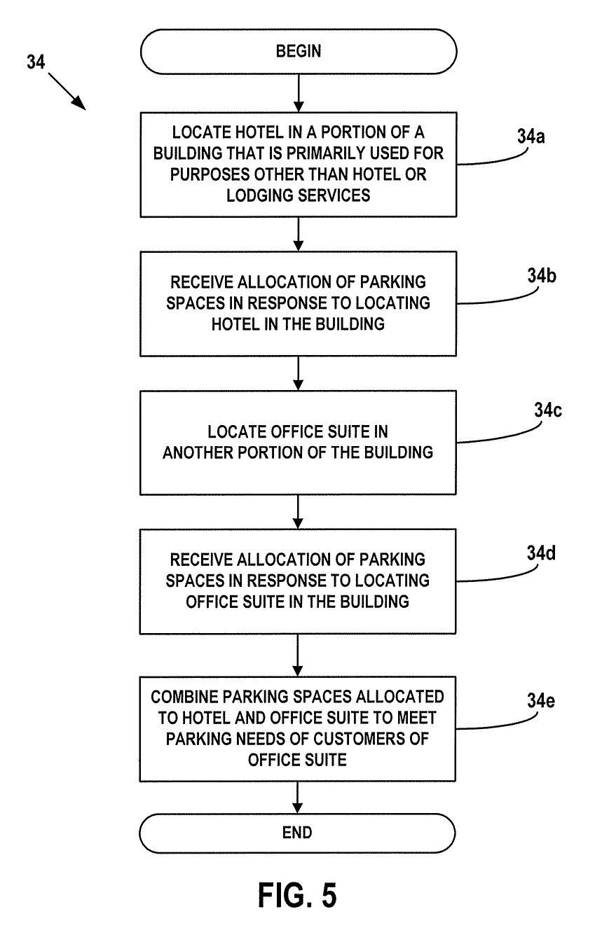

In an exemplary embodiment, as illustrated in FIG. 5 with continuing reference to FIGS. 1, 2, 3 and 4, a method 34 using the hotel system 24 is generally referred to by the reference numeral 34 and includes locating the hotel 12 in a portion of the building 16 in step 34a, which step is substantially identical to the step 20b of the method 20. In response to locating the hotel 12 in the building 16 in the step 34a, the allocation of the plurality of parking spaces 30 is received in step 34b. The method 34 further includes locating the office suite 26 in another portion of the building 16 in step 34c; receiving the allocation of the plurality of parking spaces 32 in step 34d in response to locating the office suite 26 in the building 16 in the step 34c; and, in step 34e, combining the parking spaces 30 and 32 to meet the parking needs of the customers of the office suite 26.

During operation, in an exemplary embodiment, as a result of the method 34, customers of the office suite 26 rent, lease and/or buy one or more offices in the office suite 26. In an exemplary embodiment, a common entity leases, owns and/or operates the hotel 12 and the office suite 26. In an exemplary embodiment, affiliated or contracting entities lease, own and/or operate the hotel 12 and the office suite 26, respectively. Since the hotel 12 does not require all of the parking spaces 30 for its guests, and since the office suite 26 does require all of the parking spaces 32 for its customers, the combination of the parking spaces 30 and 32 in the step 34e results in a quantity of parking spaces sufficient to the meet the parking needs of the customers of the office suite 26.

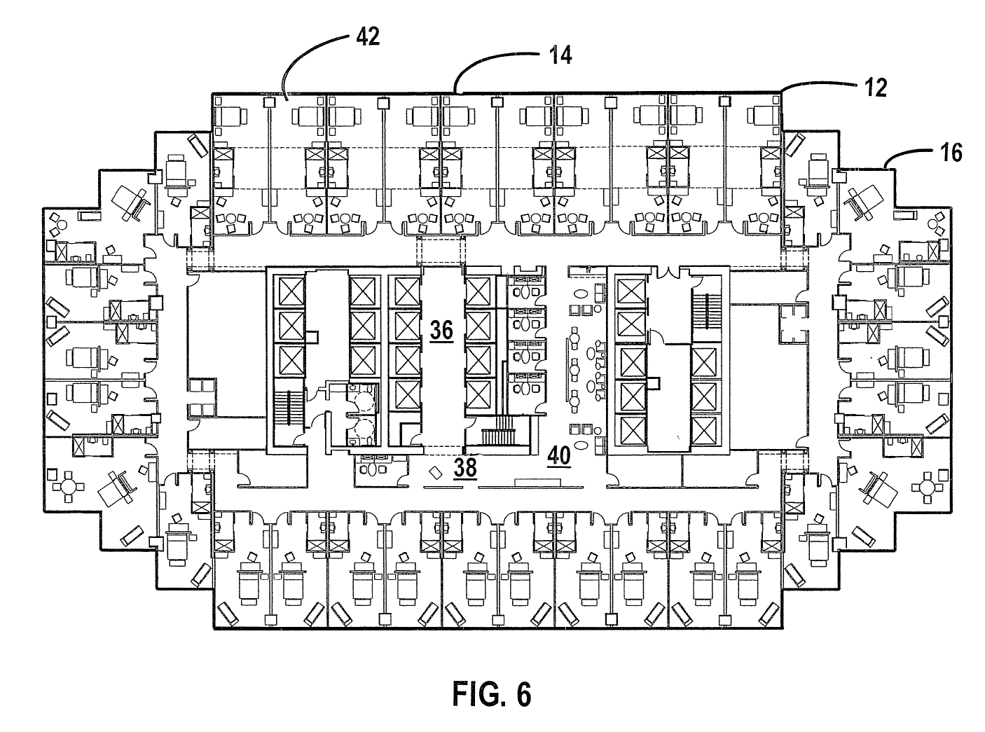

In an exemplary embodiment, as illustrated in FIG. 6 with continuing reference to FIGS. 1, 2, 3, 4, and 5, the hotel 12 includes at least an elevator lobby 36, a reception area 38, a reception/lounge area 40 and a plurality of guest rooms 42. In several exemplary embodiments, the plurality of guest rooms 42 includes different guest-room sizes and different types of guest-room arrangements.

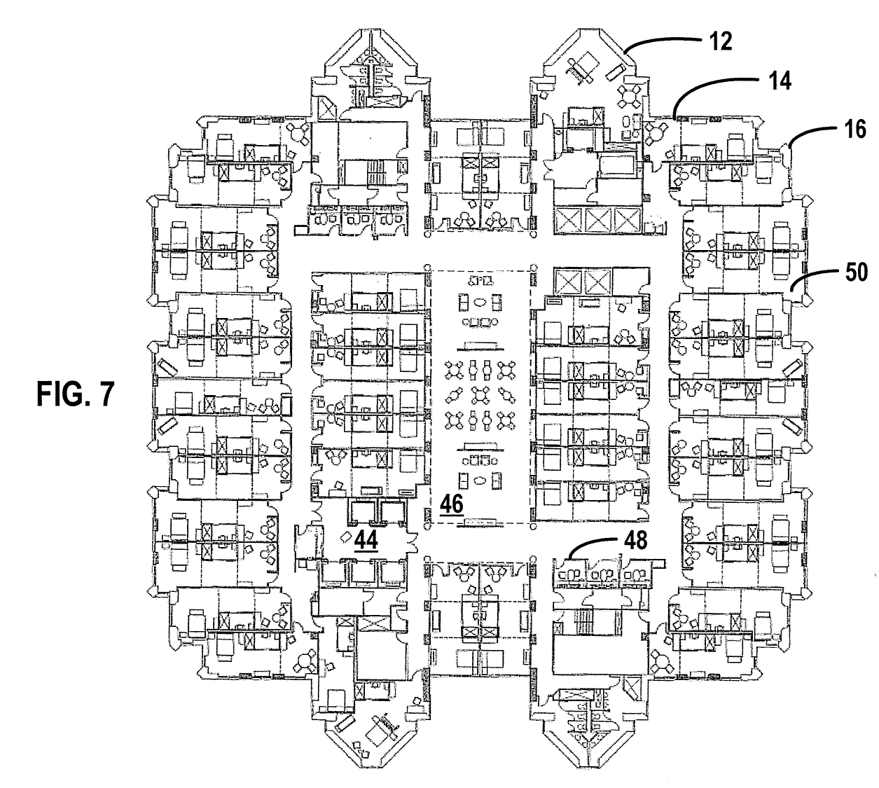

In an exemplary embodiment, as illustrated in FIG. 7 with continuing reference to FIGS. 1, 2, 3, 4, 5 and 6, the hotel 12 includes at least a reception area 44, a lounge 46, a plurality of guest offices 48, and a plurality of guest rooms 50. In several exemplary embodiments, the plurality of guest rooms 50 includes different guest-room sizes and different types of guest-room arrangements.

A method has been described that includes locating a hotel on at least one floor of a building that is primarily used for a purpose other than lodging services; providing one or more services to one or more tenants and/or visitors of the building using the hotel, the one or more services comprising lodging services; and scaling the one or more services to meet the demands of the one or more tenants and/or visitors of the building. In an exemplary embodiment, the method includes marketing the one or more services through the tenants of the building. In an exemplary embodiment, the method includes providing an office suite in the building; wherein the combination of the hotel and the office suite permits a sufficient quantity of parking spaces associated with the building to be reserved to meet the needs of the customer of the office suite. In an exemplary embodiment, the method comprises identifying the source of the one or more services using the term “HOTEL ON” followed by the floor number of the at least one floor of the building.

A hotel system has been described that includes a building that is primarily used for a purpose other than lodging services, wherein the building has one or more tenants; and a hotel located on one or more floors of the building; wherein the hotel is sized to meet the demands of the one or more tenants of the building.

A system has been described that includes means for locating a hotel on at least one floor of a building that is primarily used for a purpose other than lodging services; means for providing one or more services to one or more tenants and/or visitors of the building using the hotel, the one or more services comprising lodging services; and means for scaling the one or more services to meet the demands of the one or more tenants and/or visitors of the building. In an exemplary embodiment, the system comprises means for marketing the one or more services through the tenants of the building. In an exemplary embodiment, the system comprises means for providing an office suite in the building; wherein the combination of the hotel and the office suite permits a sufficient quantity of parking spaces associated with the building to be reserved to meet the needs of the tenants of the office suite. In an exemplary embodiment, the system comprises means for identifying the source of the one or more services using the term “HOTEL ON” followed by the floor number of the at least one floor of the building.

A hotel system has been described that includes a building that is primarily used for a purpose other than lodging services, wherein the building has one or more tenants; and a hotel located on one or more floors of the building; wherein the hotel is sized to meet the demands of the one or more tenants of the building; and wherein the hotel is identified using the term “HOTEL ON” followed by the floor number of the at least one floor of the building.

A method has been described that includes locating a hotel on at least one floor of a building that is primarily used for purposes other than lodging services, the hotel having a size; providing one or more services to one or more tenants of, and any visitors to, the building using the hotel, the one or more services comprising lodging services; scaling the size of the hotel to meet the demands of the one or more tenants of, and any visitors to, the building; and scaling the one or more services to meet the demands of the one or more tenants of, and any visitors to, the building. In an exemplary embodiment, the method comprises, marketing the one or more services, comprising one of identifying the source of the one or more services using the term “HOTEL ON” followed by the floor number of the at least one floor of the building; and conducting direct marketing of the one or more services through the tenants of the building. In an exemplary embodiment, marketing the one or more services comprises the other of identifying the source of the one or more services using the term “HOTEL ON” followed by the floor number of the at least one floor of the building; and conducting direct marketing of the one or more services through the tenants of the building. In an exemplary embodiment, a non-hotel portion of the building is defined in response to locating the hotel on the at least one floor of the building; wherein scaling the size of the hotel to meet the demands of the one or more tenants of, and any visitors to, the building comprises determining the size of the building; and after determining the size of the building, sizing the hotel so that the size of the hotel is less than the size of the non-hotel portion of the building. In an exemplary embodiment, the size of the hotel is a percentage of the size of the building, the percentage ranging from about 1% to about 10%. In an exemplary embodiment, the building has a tenant occupancy; wherein the one or more tenants practice respective businesses; and wherein scaling the one or more services to meet the demands of the one or more tenants of, and any visitors to, the building comprises one or more of the following: determining the tenant occupancy of the building; and determining the businesses practiced by the one or more tenants. In an exemplary embodiment, scaling the one or more services to meet the demands of the one or more tenants of, and any visitors to, the building comprises conducting one or more surveys of the one or more tenants of the building; and scaling the one or more services in response to the results of the one or more surveys. In an exemplary embodiment, the method comprises receiving an allocation of a first plurality of parking spaces in response to locating the hotel on the at least one floor of the building; locating an office suite in the building; receiving an allocation of a second plurality of parking spaces in response to locating the office suite in the building; providing office-related services to customers of the office suite, the customers having parking needs; and combining the allocations of the first and second pluralities of parking spaces to meet the parking needs of the customers of the office suite. In an exemplary embodiment, the method comprises marketing the one or more services, comprising at least one of identifying the source of the one or more services using the term “HOTEL ON” followed by the floor number of the at least one floor of the building; and conducting direct marketing of the one or more services through the tenants of the building; wherein a non-hotel portion of the building is defined in response to locating the hotel on the at least one floor of the building; wherein scaling the size of the hotel to meet the demands of the one or more tenants of, and any visitors to, the building comprises determining the size of the building; and after determining the size of the building, sizing the hotel so that the size of the hotel is less than the size of the non-hotel portion of the building; wherein the size of the hotel is a percentage of the size of the building, the percentage ranging from about 1% to about 10%; wherein the building has a tenant occupancy; wherein the one or more tenants practice respective businesses; and wherein scaling the one or more services to meet the demands of the one or more tenants of, and any visitors to, the building comprises determining the tenant occupancy of the building; determining the businesses practiced by the one or more tenants; conducting one or more surveys of the one or more tenants of the building; and scaling the one or more services in response to the results of the one or more surveys.

A system has been described that includes means for locating a hotel on at least one floor of a building that is primarily used for purposes other than lodging services, the hotel having a size; means for providing one or more services to one or more tenants of, and any visitors to, the building using the hotel, the one or more services comprising lodging services; means for scaling the size of the hotel to meet the demands of the one or more tenants of, and any visitors to, the building; and means for scaling the one or more services to meet the demands of the one or more tenants of, and any visitors to, the building. In an exemplary embodiment, the system comprises means for marketing the one or more services, comprising one of means for identifying the source of the one or more services using the term “HOTEL ON” followed by the floor number of the at least one floor of the building; and means for conducting direct marketing of the one or more services through the tenants of the building. In an exemplary embodiment, means for marketing the one or more services comprises the other of means for identifying the source of the one or more services using the term “HOTEL ON” followed by the floor number of the at least one floor of the building; and means for conducting direct marketing of the one or more services through the tenants of the building. In an exemplary embodiment, a non-hotel portion of the building is defined in response to locating the hotel on the at least one floor of the building; wherein means for scaling the size of the hotel to meet the demands of the one or more tenants of, and any visitors to, the building comprises means for determining the size of the building; and means for after determining the size of the building, sizing the hotel so that the size of the hotel is less than the size of the non-hotel portion of the building. In an exemplary embodiment, the size of the hotel is a percentage of the size of the building, the percentage ranging from about 1% to about 10%. In an exemplary embodiment, the building has a tenant occupancy; wherein the one or more tenants practice respective businesses; and wherein means for scaling the one or more services to meet the demands of the one or more tenants of, and any visitors to, the building comprises one or more of the following: means for determining the tenant occupancy of the building; and means for determining the businesses practiced by the one or more tenants. In an exemplary embodiment, means for scaling the one or more services to meet the demands of the one or more tenants of, and any visitors to, the building comprises means for conducting one or more surveys of the one or more tenants of the building; and means for scaling the one or more services in response to the results of the one or more surveys. In an exemplary embodiment, the system comprises means for receiving an allocation of a first plurality of parking spaces in response to locating the hotel on the at least one floor of the building; means for locating an office suite in the building; means for receiving an allocation of a second plurality of parking spaces in response to locating the office suite in the building; means for providing office-related services to customers of the office suite, the customers having parking needs; and means for combining the allocations of the first and second pluralities of parking spaces to meet the parking needs of the customers of the office suite. In an exemplary embodiment, the system comprises means for marketing the one or more services, comprising at least one of means for identifying the source of the one or more services using the term “HOTEL ON” followed by the floor number of the at least one floor of the building; and means for conducting direct marketing of the one or more services through the tenants of the building; wherein a non-hotel portion of the building is defined in response to locating the hotel on the at least one floor of the building; wherein means for scaling the size of the hotel to meet the demands of the one or more tenants of, and any visitors to, the building comprises means for determining the size of the building; and means for after determining the size of the building, sizing the hotel so that the size of the hotel is less than the size of the non-hotel portion of the building; wherein the size of the hotel is a percentage of the size of the building, the percentage ranging from about 1% to about 10%; wherein the building has a tenant occupancy; wherein the one or more tenants practice respective businesses; and wherein means for scaling the one or more services to meet the demands of the one or more tenants of, and any visitors to, the building comprises means for determining the tenant occupancy of the building; means for determining the businesses practiced by the one or more tenants; means for conducting one or more surveys of the one or more tenants of the building; and means for scaling the one or more services in response to the results of the one or more surveys.

A system has been described that includes a building that is primarily used for purposes other than lodging services, wherein the building has one or more tenants; and a hotel located on one or more floors of the building and adapted to provide lodging services, wherein a non-hotel portion of the building is defined by the location of the hotel in the building; wherein the size of the hotel is less than the size of the non-hotel portion of the building; wherein the hotel is sized to meet the demands of the one or more tenants of the building; and wherein the lodging services provided by the hotel are scaled to meet the demands of the one or more tenants of the building. In an exemplary embodiment, the system comprises an office suite located in the building and adapted to provide office-related services to customers of the office suite, the customers having parking needs; a first plurality of parking spaces allocated to the hotel; and a second plurality of parking spaces allocated to the office suite; wherein the sum of the parking spaces in the first and second pluralities of parking spaces is sufficient to meet the parking needs of the customers of the office suite.

It is understood that variations may be made in the foregoing without departing from the scope of the disclosure. In several exemplary embodiments, instead of, or in addition to an office building, the building 16 may be, for example, a hospital, a government building, a mixed-use building, or another type of building.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “top,” “bottom,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A method comprising:
locating a hotel on at least one floor of a building that is primarily used for purposes other than lodging services, the hotel having a size;
providing one or more services to one or more tenants of, and any visitors to, the building using the hotel, the one or more services comprising lodging services;
scaling the size of the hotel to meet the demands of the one or more tenants of, and any visitors to, the building; and
scaling the one or more services to meet the demands of the one or more tenants of, and any visitors to, the building.

2. The method of claim 1 further comprising:
marketing the one or more services, comprising one of:
identifying the source of the one or more services using the term “HOTEL ON” followed by the floor number of the at least one floor of the building; and
conducting direct marketing of the one or more services through the tenants of the building.

3. The method of claim 2 wherein marketing the one or more services comprises the other of:
identifying the source of the one or more services using the term “HOTEL ON” followed by the floor number of the at least one floor of the building; and
conducting direct marketing of the one or more services through the tenants of the building.

4. The method of claim 1 wherein a non-hotel portion of the building is defined in response to locating the hotel on the at least one floor of the building;
wherein scaling the size of the hotel to meet the demands of the one or more tenants of, and any visitors to, the building comprises:
determining the size of the building; and
after determining the size of the building, sizing the hotel so that the size of the hotel is less than the size of the non-hotel portion of the building.

5. The method of claim 4 wherein the size of the hotel is a percentage of the size of the building, the percentage ranging from about 1% to about 10%.

6. The method of claim 1 wherein the building has a tenant occupancy;
wherein the one or more tenants practice respective businesses; and
wherein scaling the one or more services to meet the demands of the one or more tenants of, and any visitors to, the building comprises one or more of the following:
determining the tenant occupancy of the building; and
determining the businesses practiced by the one or more tenants.

7. The method of claim 1 wherein scaling the one or more services to meet the demands of the one or more tenants of, and any visitors to, the building comprises:
conducting one or more surveys of the one or more tenants of the building; and
scaling the one or more services in response to the results of the one or more surveys.

8. The method of claim 1 further comprising:
receiving an allocation of a first plurality of parking spaces in response to locating the hotel on the at least one floor of the building;
locating an office suite in the building;
receiving an allocation of a second plurality of parking spaces in response to locating the office suite in the building;
providing office-related services to customers of the office suite, the customers having parking needs; and
combining the allocations of the first and second pluralities of parking spaces to meet the parking needs of the customers of the office suite.

9. The method of claim 1 further comprising:
marketing the one or more services, comprising at least one of:
identifying the source of the one or more services using the term “HOTEL ON” followed by the floor number of the at least one floor of the building; and
conducting direct marketing of the one or more services through the tenants of the building;
wherein a non-hotel portion of the building is defined in response to locating the hotel on the at least one floor of the building;
wherein scaling the size of the hotel to meet the demands of the one or more tenants of, and any visitors to, the building comprises:
determining the size of the building; and
after determining the size of the building, sizing the hotel so that the size of the hotel is less than the size of the non-hotel portion of the building;
wherein the size of the hotel is a percentage of the size of the building, the percentage ranging from about 1% to about 10%;
wherein the building has a tenant occupancy;
wherein the one or more tenants practice respective businesses; and
wherein scaling the one or more services to meet the demands of the one or more tenants of, and any visitors to, the building comprises:
determining the tenant occupancy of the building;
determining the businesses practiced by the one or more tenants;
conducting one or more surveys of the one or more tenants of the building; and
scaling the one or more services in response to the results of the one or more surveys.

10. A system comprising:
means for locating a hotel on at least one floor of a building that is primarily used for purposes other than lodging services, the hotel having a size;
means for providing one or more services to one or more tenants of, and any visitors to, the building using the hotel, the one or more services comprising lodging services;
means for scaling the size of the hotel to meet the demands of the one or more tenants of, and any visitors to, the building; and
means for scaling the one or more services to meet the demands of the one or more tenants of, and any visitors to, the building.

11. The system of claim 10 further comprising:
means for marketing the one or more services, comprising one of:
means for identifying the source of the one or more services using the term “HOTEL ON” followed by the floor number of the at least one floor of the building; and
means for conducting direct marketing of the one or more services through the tenants of the building.

12. The system of claim 11 wherein means for marketing the one or more services comprises the other of:
means for identifying the source of the one or more services using the term “HOTEL ON” followed by the floor number of the at least one floor of the building; and
means for conducting direct marketing of the one or more services through the tenants of the building.

13. The system of claim 10 wherein a non-hotel portion of the building is defined in response to locating the hotel on the at least one floor of the building;
wherein means for scaling the size of the hotel to meet the demands of the one or more tenants of, and any visitors to, the building comprises:
means for determining the size of the building; and
means for after determining the size of the building, sizing the hotel so that the size of the hotel is less than the size of the non-hotel portion of the building.

14. The system of claim 13 wherein the size of the hotel is a percentage of the size of the building, the percentage ranging from about 1% to about 10%.

15. The system of claim 10 wherein the building has a tenant occupancy;
wherein the one or more tenants practice respective businesses; and
wherein means for scaling the one or more services to meet the demands of the one or more tenants of, and any visitors to, the building comprises one or more of the following:
means for determining the tenant occupancy of the building; and
means for determining the businesses practiced by the one or more tenants.

16. The system of claim 10 wherein means for scaling the one or more services to meet the demands of the one or more tenants of, and any visitors to, the building comprises:
means for conducting one or more surveys of the one or more tenants of the building; and
means for scaling the one or more services in response to the results of the one or more surveys.

17. The system of claim 10 further comprising:
means for receiving an allocation of a first plurality of parking spaces in response to locating the hotel on the at least one floor of the building;
means for locating an office suite in the building;
means for receiving an allocation of a second plurality of parking spaces in response to locating the office suite in the building;
means for providing office-related services to customers of the office suite, the customers having parking needs; and
means for combining the allocations of the first and second pluralities of parking spaces to meet the parking needs of the customers of the office suite.

18. The system of claim 10 further comprising:
means for marketing the one or more services, comprising at least one of:
means for identifying the source of the one or more services using the term “HOTEL ON” followed by the floor number of the at least one floor of the building; and
means for conducting direct marketing of the one or more services through the tenants of the building;
wherein a non-hotel portion of the building is defined in response to locating the hotel on the at least one floor of the building;
wherein means for scaling the size of the hotel to meet the demands of the one or more tenants of, and any visitors to, the building comprises:
means for determining the size of the building; and
means for after determining the size of the building, sizing the hotel so that the size of the hotel is less than the size of the non-hotel portion of the building;
wherein the size of the hotel is a percentage of the size of the building, the percentage ranging from about 1% to about 10%;
wherein the building has a tenant occupancy;
wherein the one or more tenants practice respective businesses; and
wherein means for scaling the one or more services to meet the demands of the one or more tenants of, and any visitors to, the building comprises:
means for determining the tenant occupancy of the building;
means for determining the businesses practiced by the one or more tenants;
means for conducting one or more surveys of the one or more tenants of the building; and
means for scaling the one or more services in response to the results of the one or more surveys.

19. A system comprising:
a building that is primarily used for purposes other than lodging services, wherein the building has one or more tenants; and
a hotel located on one or more floors of the building and adapted to provide lodging services, wherein a non-hotel portion of the building is defined by the location of the hotel in the building;
wherein the size of the hotel is less than the size of the non-hotel portion of the building;
wherein the hotel is sized to meet the demands of the one or more tenants of the building; and
wherein the lodging services provided by the hotel are scaled to meet the demands of the one or more tenants of the building.

20. The system of claim 19 further comprising:
an office suite located in the building and adapted to provide office-related services to customers of the office suite, the customers having parking needs;
a first plurality of parking spaces allocated to the hotel; and
a second plurality of parking spaces allocated to the office suite;
wherein the sum of the parking spaces in the first and second pluralities of parking spaces is sufficient to meet the parking needs of the customers of the office suite.
